(19) United States
(12) Patent Application Publication
(10) Pub. No.: US 2012/0026622 A1
(43) Pub. Date: Feb. 2, 2012

(54) METHOD AND APPARATUS FOR INSPECTING MAGNETIC DISK

(75) Inventors: Kenichi SHITARA, Kamisato (JP); Takao ISHII, Ninomiya (JP)

(73) Assignee: HITACHI HIGH-TECHNOLOGIES CORPORATION, Tokyo (JP)

(21) Appl. No.: 13/188,771

(22) Filed: Jul. 22, 2011

(30) Foreign Application Priority Data
Jul. 28, 2010 (JP) 2010-169317

(51) Int. Cl. G11B 27/36

(52) U.S. Cl. 360/31; G9B/27.052

(57) ABSTRACT

In order to enable a highly-sensitive certifying test by detecting a signal with a high S/N ratio while controlling the glide height of a magnetic head to be optimized at the time of the certifying test, a method for inspecting a magnetic disk by conducting the certifying test for the magnetic disk using the magnetic head incorporating a heater includes: writing data into the magnetic disk using the magnetic head; and reading the data written into the magnetic disk using the magnetic head. Electric power applied to the heater incorporated in the magnetic head is switched between when writing the data and when reading the data.

### BACKGROUND

The present invention relates to a method and an apparatus for inspecting a magnetic disk by conducting a certifying test for the magnetic disk.

Along with increasing recording density of a magnetic disk, the glide height of a magnetic head gliding above a surface of the disk that is rotated at a high speed becomes a level of 1.5 to 1.8 nm, and is further reduced to a level of 1 nm or smaller as the density is further increased. Fine protrusions on the surface are strictly controlled for a magnetic disk for which a minute glide height is required, and it is confirmed by a glide height test that there are no protrusions on the surface of the magnetic disk that collide with the head when the head is gliding.

A certifying test that is the final inspection process for a magnetic disk includes a test (read/write test) in which data are written into the disk that has passed the glide height test using a head for a test, and the written data are read.

The main items of the certifying test include a parametric test in which electric characteristics are examined at plural points on the magnetic disk, and a defect test on the whole surface of the disk.

Japanese Patent Application Laid-Open Publication No. H9-259401 describes that the glide height test and the certifying test are simultaneously conducted using an output from one test head.

Further, Japanese Patent Application Laid-Open Publication No. 2001-143201 describes that the certifying test is conducted, at small track pitches, for a magnetic disk with the small number of minute surface defects, and the certifying test is conducted, at large inspection track pitches, for a magnetic disk with the large number of minute surface defects in accordance with the result of the glide height test.

Furthermore, Japanese Patent Application Laid-Open Publication No. 2009-199660 describes that a magnetic head having a heating element that controls the protrusion amount of the head is allowed to glide at a low height while controlling the glide height at a set height to improve the quality of a signal, and defects are inspected using a signal read by the head while controlling the glide height to be different from that set by heating the heating element.

Along with increasing recording density of a magnetic disk, there has been increasing demand of a highly-sensitive certifying test.

In the technique described in Japanese Patent Application Laid-Open Publication No. H9-259401, it can be expected that the throughput of the inspection can be improved by simultaneously conducting the glide height test and the certifying test using an output from one test head. However, there is no consideration of suppressing variations in inspection sensitivity caused by variations in characteristics of test heads among plural inspection apparatuses.

Further, in the technique described in Japanese Patent Application Laid-Open Publication No. 2001-143201, the efficiency of the inspection can be improved by conducting the certifying test in accordance with the result of the glide height test. However, there is no consideration of suppressing variations in inspection sensitivity caused by variations in characteristics of test heads among plural inspection apparatuses at the time of conducting the certifying test.

Furthermore, in Japanese Patent Application Laid-Open Publication No. 2009-199660, the inspection is conducted while shifting the glide height by heating the magnetic head from the optimum head glide height at which a signal with a high S/N ratio can be detected while suppressing generation of reduction in thermal asperity that is generated by the magnetic head colliding with protrusions of the surface of the magnetic disk, so that defects can be detected under the same environment as the operation. However, there is no description about implementation of a highly-sensitive certifying test.

### SUMMARY

The present invention provides a method and an apparatus for conducting a certifying test which enable a highly-sensitive certifying test by detecting a signal with a high S/N ratio while controlling the glide height of a magnetic head to be optimized at the time of conducting the certifying test.

In order to achieve the above-described object, an aspect of the present invention provides a method for inspecting a magnetic disk including: obtaining a relation between electric power applied to a heater and the number of error counts by conducting a read/write test at a predetermined area of the magnetic disk using a magnetic head while changing the glide height of the magnetic head gliding above the magnetic disk being rotated by controlling the electric power applied to the heater incorporated in the magnetic head; setting the electric power applied to the heater at the time of conducting the read/write test on the basis of the obtained relation between the electric power applied to the heater and the number of error counts; applying the set electric power to the heater; and conducting the read/write test at the predetermined area of the magnetic disk using the magnetic head in a state where the set electric power is applied to the heater.

Further, in order to achieve the above-described object, another aspect of the present invention provides a method for inspecting a magnetic disk by conducting a certifying test for the magnetic disk using a magnetic head incorporating a heater, the method including: writing data into the magnetic disk using the magnetic head; and reading the data written into the magnetic disk using the magnetic head, wherein electric power applied to the heater incorporated in the magnetic head is switched between when writing the data and when reading the data.

Further, in order to achieve the above-described object, another aspect of the present invention provides an apparatus for inspecting a magnetic disk by conducting a certifying test, the apparatus including: a stage on which the magnetic disk as an inspection target sample is mounted to be rotated and to be moved in one axis direction; a magnetic head in which a heater is incorporated; a heater electric power control circuit that controls electric power applied to the heater; a current driving circuit that controls a current value applied to the magnetic head; a voltage detecting circuit that detects the voltage of the magnetic head in which current is allowed to flow by the current driving circuit; a data reading/writing circuit that writes data into the magnetic disk and reads the written data through the magnetic head; and a controller that controls the certifying test for the magnetic disk, wherein the heater electric power control circuit, the current driving circuit, and the voltage detecting circuit are formed as one IC chip.

According to the present invention, it is possible to conduct a highly-sensitive certifying test by detecting a signal with a high S/N ratio while controlling the glide height of a magnetic head to be optimized at the time of conducting the certifying test.

These features and advantages of the invention will be apparent from the following more particular description of preferred embodiments of the invention, as illustrated in the accompanying drawings.

### BRIEF DESCRIPTION OF THE DRAWINGS

FIG. 1 is a block diagram for showing an outlined configuration of an inspection apparatus that conducts a certifying test;

FIG. 2 is a cross-sectional view of a magnetic head gliding above a substrate;

FIG. 3 is a graph for showing a relation between electric power applied to a heater incorporated in the magnetic head and the number of error counts on the substrate detected by the magnetic head;

FIG. 4 is a flowchart for showing processes of the certifying test while controlling the glide height of the magnetic head according to a first embodiment of the present invention; and

FIG. 5 is a flowchart for showing processes of the certifying test while controlling the glide height of the magnetic head according to a second embodiment of the present invention.

### DESCRIPTION OF THE PREFERRED EMBODIMENTS

Hereinafter, embodiments of the present invention will be described using the drawings.

### First Embodiment

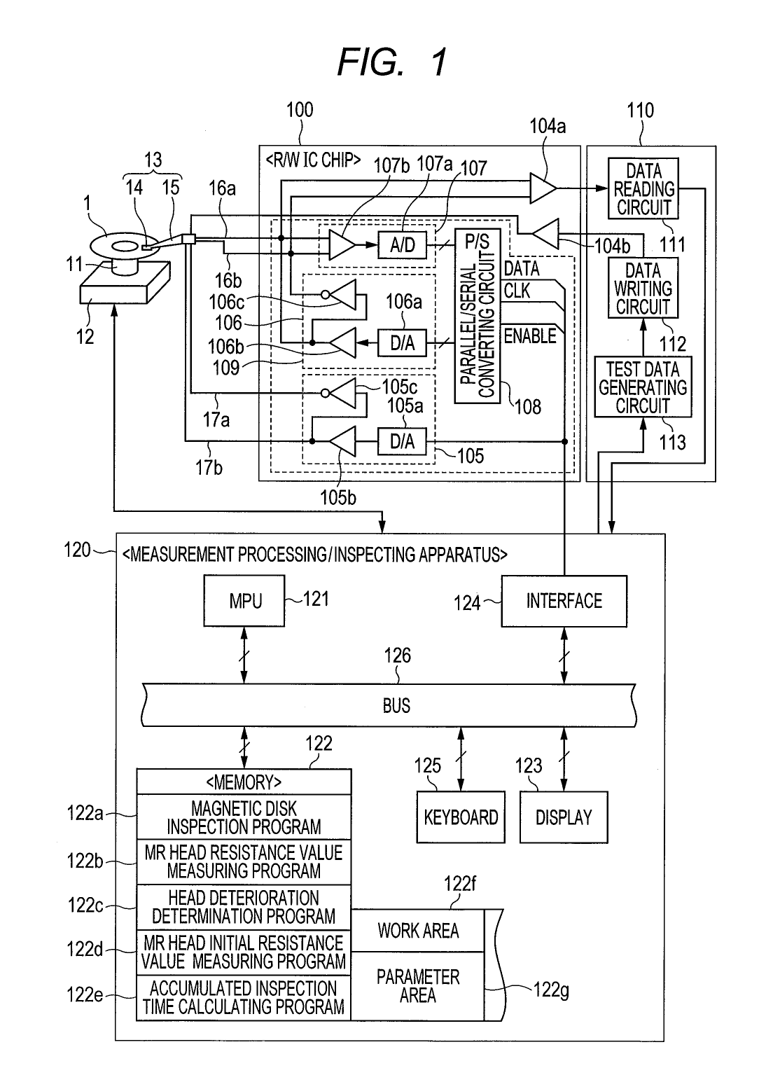

A configuration of an inspection apparatus that conducts a certifying test for a magnetic disk in a first embodiment is shown in FIG. 1.

The inspection apparatus includes a mechanism 10, a reading/writing circuit 100, a data reading/writing circuit 110, and a data processor/storage 120.

The mechanism 10 includes a rotational shaft (spindle shaft) 11 that allows a magnetic disk 1 for inspection to be mounted and rotated, a movable stage 12 that allows the rotational shaft 11 to be moved in a plane, a head element 13 that writes and reads data into/from the magnetic disk (substrate) 1, and a head arm 15 that supports the head element 13.

Here, as the head element 13, a composite magnetic head composed of an MR (magnetoresistive effect) head for reading and a thin-film inductive head for writing is used.

The reading/writing circuit 100 is formed as one chip including a reading amplifier 104a, a writing amplifier 104b, a head heating control circuit 105, a current driving circuit 106, a voltage detecting circuit 107, and a parallel/serial converter 108.

The head heating control circuit 105 includes a D/A converter 105a, a current output OP amplifier 105b, and a current inversion OP amplifier 105c.

The current driving circuit 106 includes a D/A converter 106a, a current output OP amplifier 106b, and a current inversion OP amplifier 106c, and the voltage detecting circuit 107 includes an A/D converter 107a and a high input impedance OP amplifier 107b.

The data reading/writing circuit 110 includes a data reading circuit 111, a data writing circuit 112, and a test data generating circuit 113.

The data processor/storage 120 includes an MPU 121, a memory 122, a display 123, an interface 124, a keyboard 125, and a bus 126 that couples these units to each other. A magnetic disk inspection program 122a, an MR head resistance value measuring program 122b, a head deterioration determination program 122c, an MR head initial resistance value measuring program 122d, an accumulated inspection time calculating program 122e, and the like are stored in the memory 122. Further, a work area 122f and a parameter area 122g for measurement are set.

In the above-described configuration, the head heating control circuit 105 controls electric power applied to a heater inside the head element 14 on the basis of head heating data stored in the work area 122f of the data processor/storage 120.

In the current driving circuit 106, the D/A converter 106a inputs a command from the parallel/serial converter 108, and converts the input signal from digital to analog to be output to the current output OP amplifier 106b. The current output OP amplifier 106b outputs current amplified in response to the output from the D/A converter 106a. The output current is applied to the head element 14 located at a tip end of the head arm 15 through a reading signal line 16a, and the current flowing into the head element 14 is sunk at the current inversion OP amplifier 106c of the current driving circuit 106 through a reading signal line 16b.

In the voltage detecting circuit 107, the A/D converter 107b inputs signals from the reading signal lines 16a and 16b, and outputs a voltage signal, as a measurement signal, in accordance with a potential difference (voltage) between the lines to the A/D converter 107a. The A/D converter 107a receives and converts the measurement signal from analog to digital, and outputs the digital signal to the parallel/serial converting circuit 108.

The parallel/serial converting circuit 108 calculates the resistance value of the head element 14 on the basis of the current value set by the current driving circuit 106 and the voltage value detected by the voltage detecting circuit 107, and transmits a signal to the data processor/storage 120.

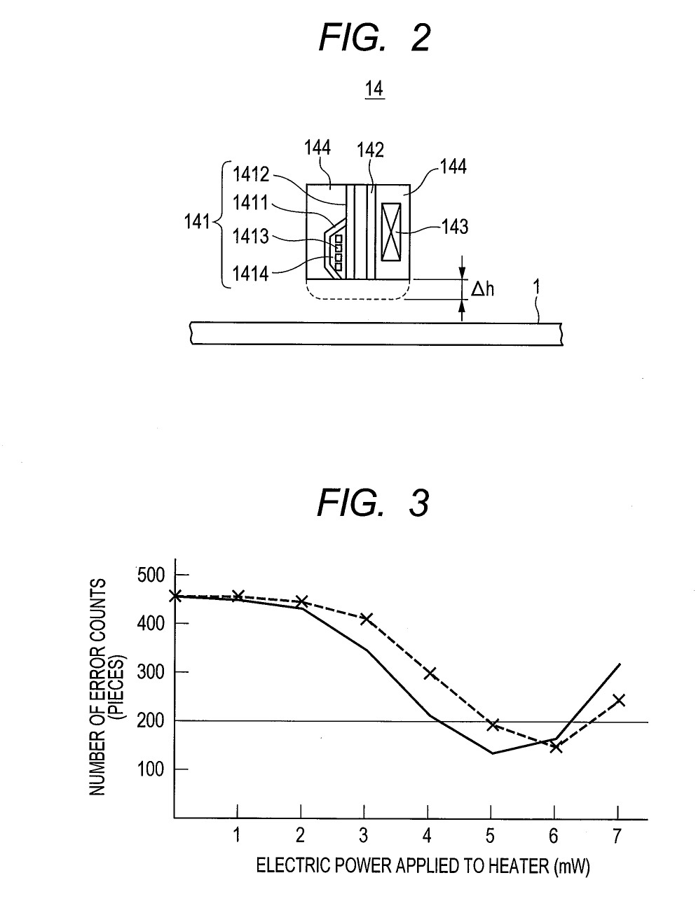

Next, as a configuration of the head element 14, an example of a partial cross-section of the MR head is shown in FIG. 2.

The partial cross-section of the head element 14 shown in FIG. 2 includes a write element 141, a read element 142, a heater 143, and a resin 144. Further, the write element 141 includes an upper electrode 1411, a lower electrode 1412, a coil 1413, and an insulating material 1414. FIG. 2 shows a state in which the substrate 1 mounted at the rotational shaft (spindle shaft) 11 is rotated at a high speed and the head element 14 is allowed to glide above the substrate 1.

In this configuration, the heater 143 is coupled to wirings 17a and 17b for the heater shown in FIG. 1 (not shown in FIG. 2), and the electric power to be applied is controlled on the basis of the head heating data stored in the work area 122f of the data processor/storage 120.

In FIG. 2, an area represented by the dotted line on the lower side of the head element 14 shows a state in which when the electric power applied to the heater 143 is increased, the head element 14 is thermally expanded. The head element 14 is expanded by heating the head element 14 using the heater 143, and a tip end of the head element protrudes towards the substrate by a head protrusion amount of Δh. Accordingly, an interval (head glide height) between the head element 14 and the substrate 1 is reduced.

On the other hand, there is a proper range for the interval between the head element 14 and the substrate 1. Specifically, if the interval between the head element 14 and the substrate 1 becomes too large, noise components are increased, resulting in deterioration in an S/N ratio. In addition, false detection in the read/write test is increased, resulting in an increase in the number of error counts. Further, if the interval between the head element 14 and the substrate 1 becomes too small, the head element 14 comes closer to the substrate 1 to collide with protrusions on a surface of the substrate 1, and the interval between the head element 14 and the substrate 1 is changed to generate a noise signal. This case also causes false detection.

As described above, by applying electric power to the heater 143 of the head element 14, the head element 14 is expanded and the interval between the substrate 1 and the head element 14 is changed. FIG. 3 shown an example of a result obtained by examining a relation between the electric power applied to the heater 143 and the number of error counts detected by the head element 14 at the time of conducting the read/write test. FIG. 3 is a diagram obtained by plotting the number of defects detected when the same area (predetermined track range) on the substrate 1 is inspected by the head element 14 while changing the electric power applied to the heater 143.

In a state where the electric power applied to the heater 143 is low, noise is increased and the possibility of false detection by the head element 14 becomes high due to the large interval between the head element 14 and the substrate 1. If the electric power applied to the heater 143 is gradually increased, the number of defects that are wrongly detected by the head element 14 is reduced, and the number becomes closer to the real number of defects. In addition, if the electric power applied is increased beyond a certain value, the number of detected defects is increased again. The dotted line in the drawing shows a moving average (an average with the previous (left side) value).

As being apparent from the graph of FIG. 3, by properly setting the interval between the head element 14 and the substrate 1, the number of defects that are wrongly detected by the head element 14 can be being reduced, and highly accurate and reliable inspection of defects can be conducted.

In the embodiment, head characteristics as shown in FIG. 3 are obtained and the electric power applied to the heater 143 is stored in the work area 122f of the data processor/storage 120 before conducting the certifying test. In the case where the certifying test is conducted, the data processor/storage 120 controls the head heating control circuit 105, so that the electric power applied to the heater 143 is set to be equal to that stored in the work area 122f.

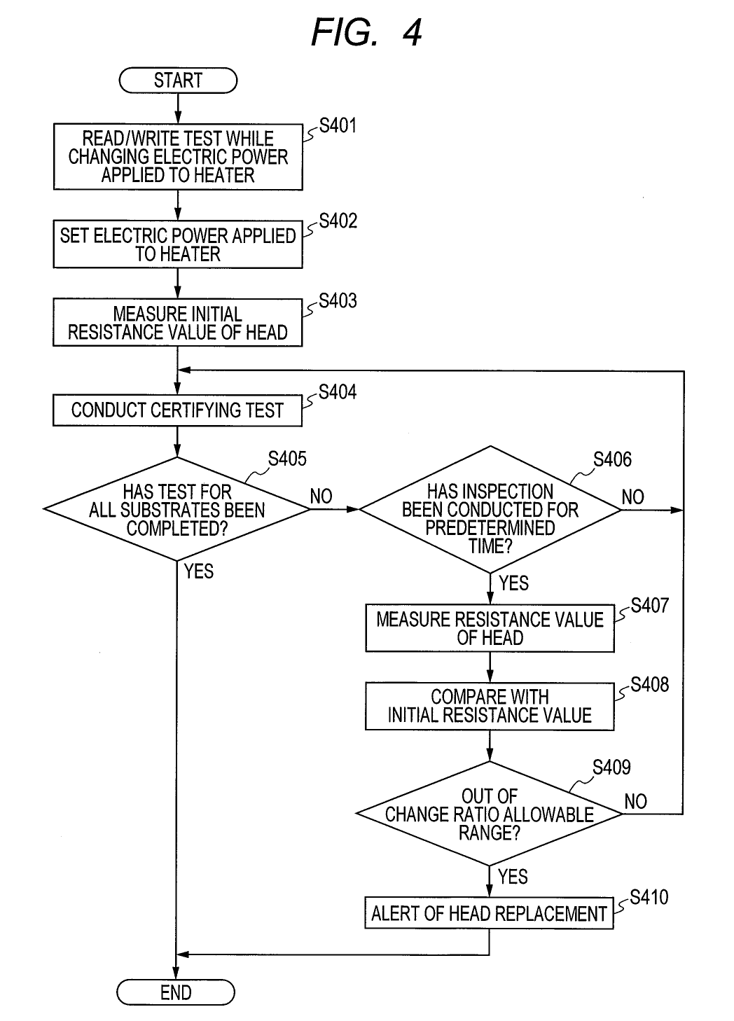

Next, FIG. 4 shows a processing flow of sequentially conducting the certifying test for the substrate 1 in a state where the data as shown in FIG. 3 are obtained in advance to determine the electric power applied to the heater 143 and the value of the electric power is stored in the work area 122f of the data processor/storage 120.

First, the MPU 121 reads the magnetic disk inspection program 122a stored in the memory of the data processor/storage 120 before conducting the certifying test. Next, a predetermined area (predetermined track area) of the substrate 1 is inspected to detect defects using the head element 14 while changing the electric power applied to the heater 143, and the relation between the electric power applied to the heater and the number of detected defects as shown FIG. 3 is obtained. In addition, the electric power applied to the heater at which the number of detected defects becomes smallest is obtained using information of the moving average on the basis of the obtained relation between the electric power applied to the heater and the number of detected defects, and is stored in the work area 122f of the data processor/storage 120 (S401).

Next, the MPU 121 controls the head heating control circuit 105 through the interface 124 to control the electric power applied to the heater 143 on the basis of the information of the electric power applied to the heater stored in the work area 122f of the data processor/storage 120 (S402).

Next, the MPU 121 reads the MR head initial resistance value measuring program 122d stored in the memory area 122 of the data processor/storage 120, and controls the current driving circuit 106 and the voltage detecting circuit 107 through the interface 124 to measure the initial resistance value of the MR head (S403). The measured initial resistance value is stored in the work area 122f of the data processor/storage 120.

After measuring the initial resistance value of the MR head, writing data are transmitted from the test data generating circuit 113 and the data writing circuit 112 of the data reading/writing circuit 110 to the head element 14 through the writing amplifier 104b by a command from the MPU 121 on the basis of the magnetic disk inspection program 122a which is read beforehand, and the data are written into the substrate 1 by the write element 141. Next, the written data are read by the read element 142 of the head element 14, and the signal thereof is input to the data reading circuit 111 through the reading amplifier 104a. The MPU 121 receives and processes the signal output from the data reading circuit 111, so that the certifying test for the substrate 1 is conducted (S404).

When the certifying test for the substrate 1 is completed, the substrate 1 is removed from the rotational shaft (spindle shaft) 11 using a handling unit (not shown). Then, check whether or not there is another substrate to be inspected for the next time (S405). If there is no substrate for inspection, the inspection is completed. On the other hand, if there is another substrate for inspection, the substrate for inspection is mounted at the rotational shaft (spindle shaft) 11 using the handling unit (not shown) and check whether or not the accumulated inspection time so far over a predetermined period of time (S406). If the accumulated inspection time is not over the predetermined period of time, the certifying test of S404 is conducted.

On the other hand, if the accumulated inspection time is over the predetermined period of time, the MPU 121 reads the MR head resistance value measuring program 122b stored in the memory area 122 of the data processor/storage 120, and controls the current driving circuit 106 and the voltage detecting circuit 107 through the interface 124 to measure the resistance value of the MR head that has conducted the inspection for the predetermined period of time (S407). Next, the measured resistance value is compared with the initial resistance value that was measured in the step of S403 and stored in the work area 122f of the data processor/storage 120 (S408) to determine whether or not a change ratio of the resistance value measured at this time to the initial resistance value falls within a predetermined range (S409). If the change ratio falls within the predetermined range, the certifying test of S404 is conducted.

On the other hand, the change ratio of the resistance value measured at this time to the initial resistance value is out of the predetermined range (out of allowable range), it is determined as deterioration of the head. Then, an alert to notify that the head should be replaced is displayed on the display of the data processor/storage 120 (S410), and the inspection is completed.

As described above, the inspection can be conducted while the glide height of the magnetic disk gliding above the substrate that is rotated at a high speed at the time of the inspection is set to conditions under which the number of error counts becomes smallest. In addition, the glide height of the magnetic head can be kept constant until the head is deteriorated due to temporal change. Thus, a highly reliable certifying test can be conducted.

### Second Embodiment

In the first embodiment, the electric power applied to the head heating heater 143 is constant at the time of conducting the read/write test.

However, there is a possibility in the read/write test that the optimum glide height of the head element 14 when writing data generated by the test data generating circuit 113 into a predetermined track area of the magnetic disk 1 by the write element 141 is different from that when reading the data from the magnetic disk 1 by the read element 142.

Accordingly, in the second embodiment, the relation between the electric power applied to the heater 143 and the number of error counts at the time of data writing and the relation between the electric power applied to the heater 143 and the number of error counts at the time of data reading in the steps of S401 and S402 of the processing flow in the first embodiment shown in FIG. 4 are separately obtained, and are stored in the work area 122f of the data processor/storage 120.

A configuration of an inspection apparatus in the second embodiment is the same as that of the inspection apparatus in the first embodiment explained using FIG. 1.

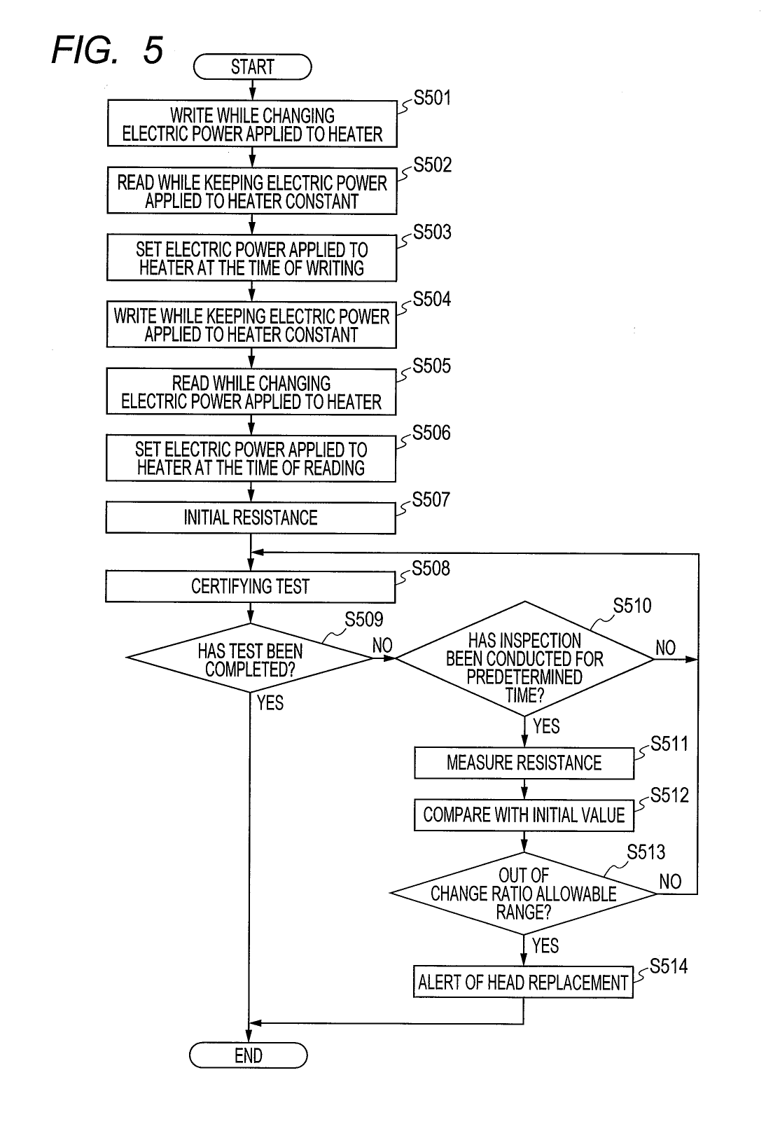

A processing flow of the second embodiment is shown in FIG. 5.

First, the MPU 121 reads the magnetic disk inspection program 122a stored in the memory of the data processor/storage 120 before conducting the certifying test. Next, inspection data generated by the test data generating circuit 113 are written into a predetermined area (predetermined track area) of the substrate 1 using the write element 141 of the head element 14 while changing the electric power applied to the heater 143 (S501). Next, the data written into the substrate 1 are read by the read element 142 in a state where the electric power applied to the heater 143 is kept constant (S502), and the electric power applied to the heater at which the number of detected defects becomes smallest at the time of data writing is obtained using the information of the moving average on the basis of the relation between the electric power applied to the heater and the number of error counts at the time of inspection data writing as shown in FIG. 3. The obtained electric power is stored in the work area 122f of the data processor/storage 120 as electric power Pw applied to the heater at the time of data writing (S503).

Next, the inspection data generated by the test data generating circuit 113 are written into the predetermined area (predetermined track area) of the substrate 1 using the write element 141 of the head element 14 (S504), and the data written into the predetermined area of the substrate 1 are read by the read element 142 while changing the electric power applied to the heater 143 (S505). Then, obtaining the electric power applied to the heater 143 to minimize the number of error counts at the time of data reading by using the information of the moving average on the basis of the relation between the electric power applied to the heater and the number of error counts at the time of inspection data writing as shown in FIG. 3. The obtained electric power is stored in the work area 122f of the data processor/storage 120 as electric power Pr applied to the heater at the time of data reading (S506).

Next, the MPU 121 reads the MR head initial resistance value measuring program 122d stored in the memory area of the data processor/storage 120, and controls the current driving circuit 106 and the voltage detecting circuit 107 through interface 124 to measure the initial resistance value of the MR head (S507). The initial resistance value is stored in the work area 122f of the data processor/storage 120.

After measuring the initial resistance value of the MR head, writing data are transmitted from the test data generating circuit 113 and the data writing circuit 112 of the data reading/writing circuit 110 to the head element 14 through the writing amplifier 104b by a command from the MPU 121 on the basis of the magnetic disk inspection program 122a which is read beforehand, and the data are written into the substrate 1 by the write element 141. At this time, the electric power Pw for data writing is applied to the heater 143 which was obtained in the step of S503 and stored in the work area 122f of the data processor/storage 120. Next, the data written into the substrate 1 are read by the read element 142 of the head element 14. At this time, the electric power applied to the heater 143 is switched from Pw to Pr for reading data from the substrate 1 that was obtained in the step of S506 and stored in the work area 122f of the data processor/storage 120. The signal read by the read element 142 is input to the data reading circuit 111 through the reading amplifier 104a, and the MPU 121 receives and processes the signal output from the data reading circuit 111, so that the certifying test for the substrate 1 is conducted (S508).

When the certifying test for the substrate 1 is completed, the substrate 1 is removed from the rotational shaft (spindle shaft) 11 using a handling unit (not shown). Then, check whether or not there is another substrate to be inspected for the next time (S509). If there is no substrate for inspection, the inspection is completed. On the other hand, if there is another substrate for inspection, the substrate for inspection is mounted at the rotational shaft (spindle shaft) 11 using the handling unit (not shown) and check whether or not the accumulated inspection time so far over a predetermined period of time (S510). If the accumulated inspection time is not over the predetermined period of time, the certifying test of S508 is conducted.

On the other hand, if the accumulated inspection time is over the predetermined period of time, the MPU 121 reads the MR head resistance value measuring program 122b stored in the memory area 122 of the data processor/storage 120, and controls the current driving circuit 106 and the voltage detecting circuit 107 through the interface 124 to measure the resistance value of the MR head that has conducted the inspection for the predetermined period of time (S511). Next, the measured resistance value is compared with the initial resistance value that was measured in the step of S507 and stored in the work area 122f of the data processor/storage 120 (S512) to determine whether or not a change ratio of the resistance value measured at this time to the initial resistance value falls within a predetermined range (S513). If the change ratio falls within the predetermined range, the certifying test of S508 is conducted.

On the other hand, the change ratio of the resistance value measured at this time to the initial resistance value is out of the predetermined range (out of allowable range), it is determined as deterioration of the head. Then, an alert to notify that the head should be replaced is displayed on the display of the data processor/storage 120 (S514), and the inspection is completed.

According to the embodiment, the inspection can be conducted while the glide height of the magnetic head gliding above the substrate that is rotated at a high speed at the time of the read/write test is switched between when writing the inspection data into the substrate and when reading the data written into the substrate. By switching the glide height in writing and in reading, the read/write test is conducted under the condition in which the number of error counts becomes smallest. In addition, the glide height of the magnetic head can be kept constant until the head is deteriorated due to temporal change. Thus, a highly reliable certifying test can be conducted.

The present invention achieved by the inventors has been concretely described above on the basis of the embodiments. However, it is obvious that the present invention is not limited to the above-described embodiments, and can be variously modified without departing from the scope of the present invention.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

1. A method for inspecting a magnetic disk comprising:
obtaining a relation between electric power applied to a heater and the number of error counts by conducting a read/write test at a predetermined area of the magnetic disk using a magnetic head while changing the glide height of the magnetic head gliding above the magnetic disk being rotated by controlling the electric power applied to the heater incorporated in the magnetic head;
setting the electric power applied to the heater at the time of conducting the read/write test on the basis of the obtained relation between the electric power applied to the heater and the number of error counts;
applying the set electric power to the heater; and
conducting the read/write test at the predetermined area of the magnetic disk using the magnetic head in a state where the set electric power is applied to the heater.

2. The method for inspecting a magnetic disk according to claim 1, wherein when obtaining the relation between the electric power applied to the heater and the number of error counts, different relations between the electric power applied to the heater and the number of error counts are obtained when writing data into the magnetic disk and when reading the data written into the magnetic disk, and when setting the electric power applied to the heater, the electric power applied to the heater is independently set at each time of writing and reading, and the set independent electric power applied to the heater is applied at each time of writing and reading in the read/write test.

3. The method for inspecting a magnetic disk according to claim 1, wherein every time the read/write test is conducted for the predetermined number of magnetic disks, the resistance value of the magnetic head is obtained by measuring a current value applied to the magnetic head and the voltage of the magnetic head to which the current value is applied, so that the lifetime of the magnetic head is observed.

4. The method for inspecting a magnetic disk according to claim 3, wherein when observing the lifetime of the magnetic head, the initial resistance value of the magnetic head before conducting the inspection is obtained, the resistance value of the magnetic head is obtained again after the read/write test is conducted for the predetermined number of magnetic disks, a change ratio of the resistance value obtained after the read/write test is conducted for the predetermined number of magnetic disks to the obtained initial resistance value is obtained, and an alert indicating that the magnetic head is deteriorated is issued when the obtained change ratio of the resistance value is larger than a predetermined ratio.

5. A method for inspecting a magnetic disk by conducting a certifying test for the magnetic disk using a magnetic head incorporating a heater, the method comprising:
writing data into the magnetic disk using the magnetic head in a state where the magnetic disk is being rotated; and
reading the data written into the magnetic disk using the magnetic head in a state where the magnetic disk is being rotated,
wherein electric power applied to the heater incorporated in the magnetic head is switched between when writing the data and when reading the data.

6. The method for inspecting a magnetic disk according to claim 5, wherein the electric power applied to the heater incorporated in the magnetic head is switched, so that the number of error counts of the data when reading the data becomes smallest.

7. The method for inspecting a magnetic disk according to claim 5, wherein the electric power applied to the heater incorporated in the magnetic head is switched, so that the glide height of the magnetic head gliding above the magnetic disk being rotated is changed between when writing the data and when reading the data.

8. An apparatus for inspecting a magnetic disk by conducting a certifying test, the apparatus comprising:
a stage on which the magnetic disk as an inspection target sample is mounted to be rotated and to be moved in one axis direction;
a magnetic head in which a heater is incorporated;
a heater electric power control circuit that controls electric power applied to the heater;
a current driving circuit that controls a current value applied to the magnetic head;
a voltage detecting circuit that detects the voltage of the magnetic head in which current is allowed to flow by the current driving circuit;
a data reading/writing circuit that writes data into the magnetic disk and reads the written data through the magnetic head; and
a controller that controls the certifying test for the magnetic disk,
wherein the heater electric power control circuit, the current driving circuit, and the voltage detecting circuit are formed as one IC chip.

9. The apparatus for inspecting a magnetic disk according to claim 8, further comprising a heater electric power setter that sets and stores data of the electric power applied to the heater at the time of conducting the read/write test on the basis of a relation between the electric power applied to the heater and the number of error counts detected by the data reading/writing circuit.

10. The apparatus for inspecting a magnetic disk according to claim 8, further comprising a magnetic head resistance value calculator that obtains the resistance value of the magnetic head on the basis of a current value applied to the magnetic head by the current driving circuit and the voltage of the magnetic head detected by the voltage detecting circuit,
wherein the controller allows the magnetic head resistance value calculator to obtain the resistance value of the magnetic head to be compared with an initial resistance value after controlling the certifying test for a plurality of magnetic disks for a predetermined period of time, and issues an alert if the resistance value of the magnetic head is changed with respect to the initial resistance value by a certain ratio or larger.

11. The apparatus for inspecting a magnetic disk according to claim 8, wherein the heater electric power control circuit switches the electric power applied to the heater incorporated in the magnetic head between when writing data into the magnetic disk through the magnetic head by the data reading/writing circuit and when reading data written in the magnetic disk through the magnetic head by the data reading/writing circuit.
